(19) United States
(12) Patent Application Publication
(10) Pub. No.: US 2017/0366131 A1
(43) Pub. Date: Dec. 21, 2017

(54) SOLAR PANEL MOUNTING SYSTEM, METHOD AND APPARATUS

(71) Applicant: Rillito River Solar, llc, Phoenix, AZ (US)

(72) Inventors: BRIAN CECIL STEARNS, TUCSON, AZ (US); ALEXANDER GRANT BORNEMANN, PHOENIX, AZ (US)

(21) Appl. No.: 15/628,937

(22) Filed: Jun. 21, 2017

Related U.S. Application Data
(60) Provisional application No. 62/352,953, filed on Jun. 21, 2016.
(60) Provisional application No. 62/369,303, filed on Aug. 1, 2016.
(60) Provisional application No. 62/378,608, filed on Aug. 23, 2016.

(51) Int. Cl. H02S 20/23; F16B 5/00; F16B 5/06; F24J 2/52

(52) U.S. Cl. CPC H02S 20/23; F24J 2/5264; F24J 2/5258; F24J 2/5256; F16B 5/008; F16B 5/0685; F16B 5/0635; F16B 5/0088; F24J 2/5211

(57) ABSTRACT

In various embodiments, a mounting system may comprise a downslope rail, an upslope rail, a first clamp and a second clamp. The downslope rail may have a first profile and comprising a downslope face and an upslope shelf. The upslope rail may have a second profile and comprising a downslope shelf and an upslope face. The first clamp may be configured to engage the downslope face and accept the installation of a first end of a solar panel. The second clamp may be configured to engage the upslope face and retain a second end of the solar panel against a downslope shelf

### CROSS REFERENCE TO RELATED APPLICATIONS

The present application claims priority to and the benefit of U.S. Provisional Patent Application Nos. 62/352,953, filed Jun. 21, 2016, the entire contents of which is herein incorporated by reference for any purpose.

The present application also claims priority to and the benefit of U.S. Provisional Patent Application Nos. 62/369,303, filed Aug. 1, 2016, the entire contents of which is herein incorporated by reference for any purpose.

The present application also claims priority to and the benefit of U.S. Provisional Patent Application Nos. 62/378,608, filed Aug. 23, 2016, the entire contents of which is herein incorporated by reference for any purpose.

### FIELD

The present disclosure relates to solar panel mounting systems.

### SUMMARY

In various embodiments, a mounting system may comprise a downslope rail, an upslope rail, a first clamp and a second clamp. The downslope rail may have a first profile and comprising a downslope face and an upslope shelf. The upslope rail may have a second profile and comprising a downslope shelf and an upslope face. The first clamp may be configured to engage the downslope face and accept the installation of a first end of a solar panel. The second clamp may be configured to engage the upslope face and retain a second end of the solar panel against a downslope shelf

The downslope face may comprise a plurality of serrations. The first clamp may be configured to engage the plurality of serrations.

The solar panel may be configured to pivot into or rock into the first clamp. The solar panel may be configured to create an upward load on the first clamp in response to the pivoting or rocking. The solar panel may cause the first clamp to load the serrations in response to the pivoting.

The upslope shelf may include a pivot point or fulcrum. The solar panels may be configured to rock into a channel defined between the first clamp and the up slope shelf. The solar panels may rock on the pivot point or fulcrum.

The downslope rail may include a slot that is configured to receive a fastener. The first clamp may be configured to receive a portion of the fastener. The first clamp may be configured to support an array skirt. The first clamp may comprise a support slot and a support shelf. The array skirt may be configured to engage the support slot and the support shelf

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 illustrates a view of a leading edge of a solar panel mounting system including a first rail with a first profile with an array skirt, in accordance with various embodiments;

FIG. 2 illustrates a view of a leading edge of a solar panel mounting system including a first rail with a second profile, in accordance with various embodiments;

FIGS. 3A-3B illustrate upslope portions of an array with a second rail with a third profile, in accordance with various embodiments;

FIGS. 4A-4D illustrate various solar panel array configurations using the mounting system of the present disclosure, in accordance with various embodiments;

FIG. 5, illustrates a slide, in accordance with various embodiments;

FIGS. 6A-6F illustrate various installation steps for installing solar panels in an array along the leading edge of the array and upslope in the array using the mounting system of the present disclosure, in accordance with various embodiments;

FIGS. 7A-7B illustrate various leading edge rails for a solar panel mounting system, in accordance with various embodiments;

FIG. 8 illustrates a partial view of an assembly of leading edge rails for a solar panel mounting system, in accordance with various embodiments;

FIG. 9A-9C illustrate a partial view of an assembly of leading edge a solar panel mounting system with an array skirt, in accordance with various embodiments; and

FIG. 10A-10C illustrate a partial view of an assembly of leading edge a solar panel mounting system with an array skirt using the second rail along the leading edge in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the inventions, it should be understood that other embodiments may be realized and that logical, chemical and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

Also, it is to be understood that phraseology and terminology used herein with reference to device or element orientation (such as, for example, terms like “central,” “upper,” “lower,” “front,” “rear,” etc.) are only used to simplify description of embodiments of the present invention and do not alone indicate or imply that the device or element referred to must have a particular orientation. In addition, terms such as “first” and “second” are used herein for purposes of description and are not intended to indicate or imply relative importance or significance.

Solar panel mounting systems have generally been provided in two distinct types. These types include rail based systems and rail-less systems. Rail based systems may have a cheaper overall system installation cost. However, rail-less systems are generally considered faster and more efficient to install. As such, there is a need for a solar mounting system that is inexpensive and faster to install.

In various embodiments, the systems, methods, and apparatuses described herein are directed to a hybrid solar panel mounting system. In this regard, the hybrid system can provide a cheaper and more efficient solar mounting system that traditional rail based or rail-less systems.

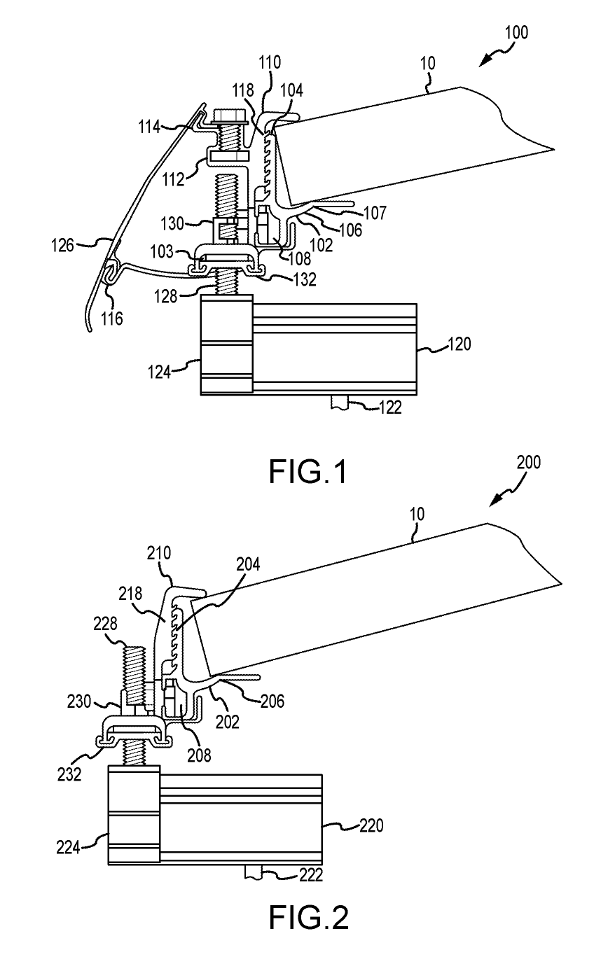

In various embodiments and with reference to FIG. 1, a portion of a solar mounting system 100 is provided. System 100 may be configured to receive, support, and secure solar panel 10. Solar mounting system 100 may comprise a downslope rail 102. Solar mounting system 100 may also comprise a first clamp 110. First clamp 110 may be operatively coupled to downslope rail 102. First clamp 110 may be coupled to downslope rail 102 by any suitable mechanism such as, for example, a fastener, inter-locking structure, an adhesive and/or the like.

In various embodiments, downslope rail 102 may comprise one or more teeth 104 (e.g., serrations, notches, steps, and/or the like). First clamp 110 may include teeth 118. Teeth 104 of downslope rail 102 may be configured to interface and interlock with teeth 118. In this regard, teeth 104may couple and/or interlock with teeth 118 thereby coupling downslope rail 102 with first clamp 110. When installed between first clamp 110 and downslope rail 102, solar panel 10 may create an upward force on first clamp 110 causing teeth 104 and teeth 118 to be retained against one another.

In various embodiments, interlocking teeth 104 and 118 of downslope rail 102 and first clamp 110, respectively, may adjustably couple to one another to accommodate solar panels of varying thicknesses (e.g., solar panels with thicknesses from 20 millimeters to 65 millimeters). The teeth 104 or teeth 118 may include one or more indicators (e.g., a symbol, number, color, and/or the like on each tooth) that allow arrangement of the interlocking teeth at specific positions to accommodate the thickness of solar panel 10 being used. In this regard, system 100 may be configured to work with, support, and/or retain any suitable solar panel, photovoltaic module, and/or the like.

In various embodiments, downslope rail 102 may include a panel shelf 106. Panel shelf 106 may be configured to receive and support at least a portion of solar panel 10. Moreover, Panel shelf 106 may define a portion of a channel between downslope rail 102 and first clamp 110. The channel may be configured to receive and retain a portion of solar panel 10. Panel shelf 106 may further comprise and/or define a fulcrum or pivot 107. A portion of a frame of solar panel 10 may be configured to contact and/or engage the pivot 107. Panel 10 may be placed on panel shelf 106 at an angle and loaded with downward pressure (e.g., pressure on the panel directed to the roof surface). The downward pressure may cause panel 10 to rotate or rock on pivot 107 into the channel defined by panel shelf 107 and first clamp 110. In this regard, panel 110 may be rocked into and secured between first clamp 110 and panel shelf 107 of downslope rail 102.

In various embodiments, first clamp 110 may also be retained on downslope rail 102. For example, downslope rail 102 may include an attachment point 108 (e.g., a slot, one or more threaded holes, a shelf, a groove and/or the like) that is capable of and/or configured to receive first clamp 110 and/or an attachment device 111 (e.g., a clamp, a shelf, a fastener, such as for example, a nut and bolt, a nut and t-bolt, and/or the like). Attachment device 111 may be integral with and/or be a portion of first clamp 110. Attachment device 111 may also be installable in and/or through first clamp 110 and downslope rail 102.

In various embodiments, first clamp 110 may include an optional array skirt attachment system. The array skirt attachment system may be configured to accept and support an array skirt 126. The array skirt attachment system may be integrally formed on and/or attached to first clamp 110. The array skirt attachment system may comprise a support shelf 114 and/or a support slot 116. For example, array skirt 126 may comprise a corresponding shelf that is installable on support shelf 114. Array skirt 126 may be retained on the array skirt attachment system at support shelf 114. For example, first clamp 110 may comprise an array skirt attachment point (e.g., a slot, one or more threaded holes, and/or the like) that is configured to receive a retention device (e.g., a fastener, a rivet, weld, solder, braze, and/or the like) to capture the shelf of the array skirt on support shelf 114. Array skirt 126 may also comprise a tab that is installable in and/or supported by support slot 116.

In various embodiments, system 100 may comprise a pedestal 124 and a slide 120. Slide 120 may be mountable to a roof surface (e.g., roof decking, a roof truss, and/or the like). Slide 120 may be mountable to the roof surface by one or more suitable fasteners 122 (e.g., a lag bolt, a screw, a nail, an adhesive, and/or the like). Slide 120 may be configured to receive and support pedestal 124. In this regard, pedestal 124 may be positionable along any point of slide 120 to allow for upslope—downslope or north—south adjustability on the roof

In various embodiments, pedestal 124 may be configured to couple to and support shaft 128. Shaft 128 may be a threaded shaft. Shaft 128 may be configured to support and/or adjust other structures in system 100 including, for example, downslope rail 102, first clamp 110, and/or the like. Shaft 128 may be configured to receive and/or be engaged by tie plate 132. Shaft 128 may also be configured to receive and/or be engaged by nut 130. Nut 130 may be a flange nut.

In various embodiments, tie plate 132 may be installed on downslope rail 102. For example, tie plate 132 may be installed in a receivable slot or channel 103 defined in downslope rail 102. Tie plate 132 may include one or more holes that allow shaft 128 to pass through tie plate 132. Tie plate 132 may also comprise one or more engagement flanges for engaging portions of downslope rail 102.

During assembly of the downslope rail of system 100, nut 130 may be positioned through a hole in downslope rail 102. Tie plate 132 may be slide into channel 103 of downslope rail 102. Tie plate 132 may include a hole that may be aligned with the hole in downslope rail 102 and the threaded hole of nut 130. Shaft 128 may be installed through the hole in tie plate 132 into the threaded hole of nut 130 allowing the shaft to pass through downslope rail 102 as nut 130 is advanced down shaft 128. In this regard, shaft 128may be retained and/or captured in downslope rail 102 by nut 130 and tie plate 132.

In various embodiments and in operation, nut 130 may be accessible from above downslope rail 120 and/or solar panel 10 allowing an installer to access and level system 100 and/or one or more solar panels 10 at each nut 130. More specifically, downslope rail 102 may translate up or down on shaft 128 based on or in response to actuation (e.g., spinning) of nut 130 on shaft 128.

In various embodiments and with reference to FIG. 2, system 200 may comprise downslope rail 202 and first clamp 210 that are installable without array skirt. In this regard, first clamp 210 may have a profile that is similar to first clap 110 as shown in FIG. 1. However, first clamp 210 may not include the bracketry, support slot or support shelf that is configured to receive an array skirt. As such, system 200 may be installed without an array skirt, but may include the leveling features provided by shaft 228, nut 230, and tie plate 232 as discussed herein. Moreover, system 200 may be adjustable on the roof with pedestal 224 installable on slide 220. System 200 will also be configured to accommodate any thickness of solar panel 10 using interlocking teeth 204 and 218 as described herein.

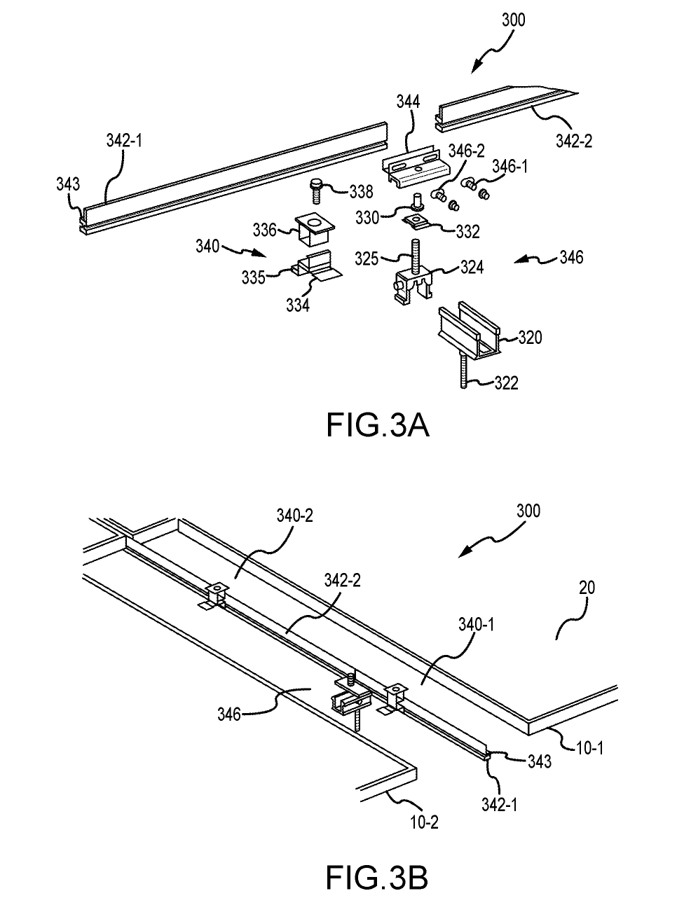

In various embodiments and with reference to FIG. 3A and FIG. 3B, mounting system 300 may comprise one or more upslope rails 342 (shown as upslope rail 342-1 and upslope rail 342-2 in FIGS. 3A and 3B). Mounting system 300 may further comprise a clip 344. Clip 344 may be installable with one or more upslope rails (e.g., clip 344 may install in a slot or channel of upslope rail 342). Clip 344 may be retained one upslope rail 342 by fastener 346. In this regard, 2 sections of upslope rail 342-1 and 342-2 may be coupled together or joined to one another via clip 344 and secured with clip 344 be fasteners 346-1 and 346-1. Fastener 346 may be any suitable fastener such as, for example, a nut and bolt, a nut and t-bolt, a bolt, a screw, a wing nut and bolt, and/or the like.

In various embodiments, upslope rail 342 may comprise a shelf 343. Shelf 343 may be integrally formed in upslope rail 342. Shelf 343 may be configured to support the face of a solar panel 10. Moreover, shelf 343 may include a slot or channel. The slot or channel may be configured to receive a fastener.

In various embodiments, system 300 may further comprise a slide 320 and a pedestal 324. Slide 320 may be secured, coupled, and/or otherwise fastened to the roof surface with any suitable fastener 322 including, for example, a lag bolt. Pedestal 324 may slidably engage slide 320 and may be positionable along any length of slide 320. Pedestal 324 may be secured on slide 320 with a set screw or other suitable attachment device.

In various embodiments, mounting system may include one or more mounting clips 340. Mounting clip 340 may be operatively coupled to upslope rail 342 at any suitable point along upslope rail 342. For example, mounting clip 340 may be positioned to engage a panel at a point as prescribed by solar panel manufacturer. Moreover, clip 340 may be adjustable along the length of upslope rail 342 which will facilitate the use of mounting system 300 with any solar panel 10. More specifically, clip 340 may be positioned at any point along upslope rail 342 to engage panel 10 at a location defined by anyone of a panel manufacturer, a system designer, an installer, an integrator, a rail manufacturer and/or the like. In this regard, mounting clip 340 is configured to make mounting system 300 customizable and universal. Mounting clip 340 may be configured to support an edge of a solar panel. In this regard, mounting clip 340 may support the trailing edge of the panel (e.g., upslope on array 20).

In various embodiments, clip 340 may comprise a top clamp portion 336 and a bottom clamp portion 334. Top clamp portion 336 and bottom clamp portion 334 may be formed as a single piece. Top clamp portion 336 and bottom clamp portion 334 may also be an assembly held together by a fastener 338. Top clamp portion 336 and bottom clamp portion 334 may be adjustable relative to one another so that they may engage and support a solar panel of any suitable thickness. Bottom clamp portion 334 may comprise an engagement arm 335 that is configured to engage and/or couple to upslope rail 342. In this regard, engagement arm 335 may be configured to engage a slot or channel in upslope rail 342. Engagement arm 335 may also partially wrap around a bottom surface of upslope rail 342. Bottom clamp portion 342 may also include a fulcrum point in the shelf allowing for a solar panel 10 to be rocked in. Top clamp portion 336 may also be removable or adjustable to allow panel 10 to be placed on the shelf defined by bottom clamp portion 334. In this regard, panel 10 may be captured between and/or positively retained by top clamp portion 336 and bottom clamp portion 334. The amount of pressure created between top clamp portion 336 and bottom clamp portion 334 may be adjusted by adjusting the fastener used to retain top clamp portion 336 and bottom clamp portion 334 together as an assembly.

In various embodiments, pedestal 324 may further comprise a support rod 325. Support rod 325 may be configured to engage and support clip 344. Support rod 325 may be operatively coupled to clip 344 with a fastener and/or a leveling system. The leveling system may include a flange nut 330 and/or a tie plate 332. Nut 330 may be installed in a channel or slot defined in clip 322. A portion of nut 330 may also pass through a hole in clip 344. Tie plate 332 may also be installed within the channel or slot of clip 344. Support rod 325 of pedestal 324 may be installable through tie plate 332 and nut 330. Support rod 325 may comprise threads that engage nut 330 and/or tie plate 332. Nut 330 may be accessible from above a solar panel array 20 (e.g., an array comprising 2 or more solar panels including, for example, solar panel 10-1, solar panel 10-1, and/or the like). In operation, nut 330 may be accessible after one or more solar panels 10 are attached to downslope rail 342 to allow the array to be leveled by turning nut 330.

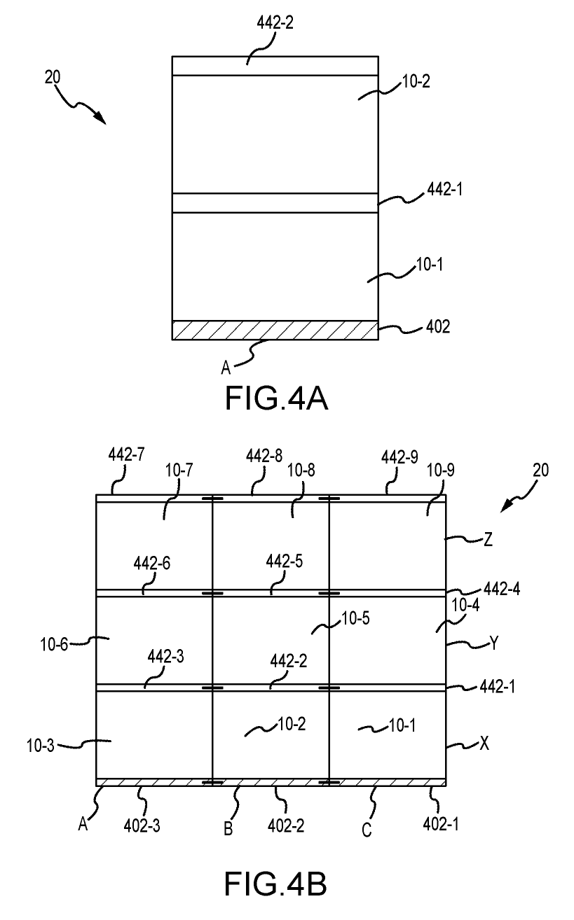

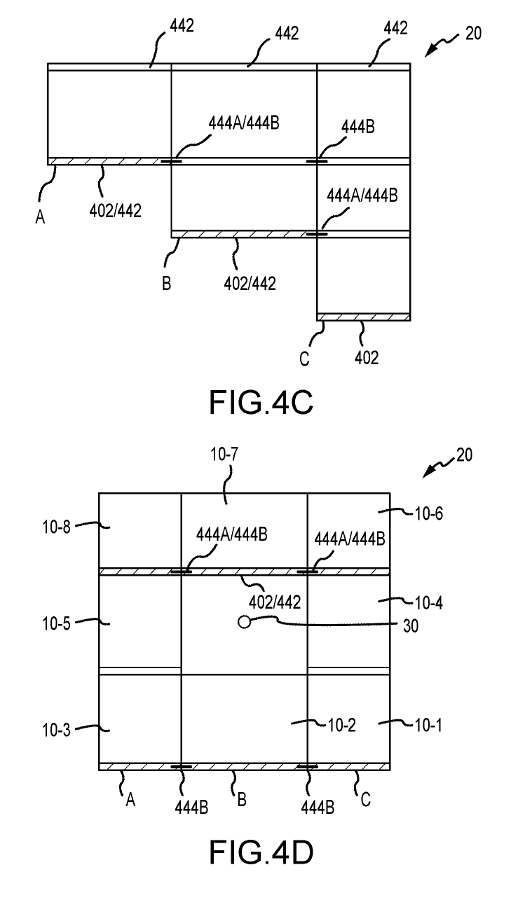

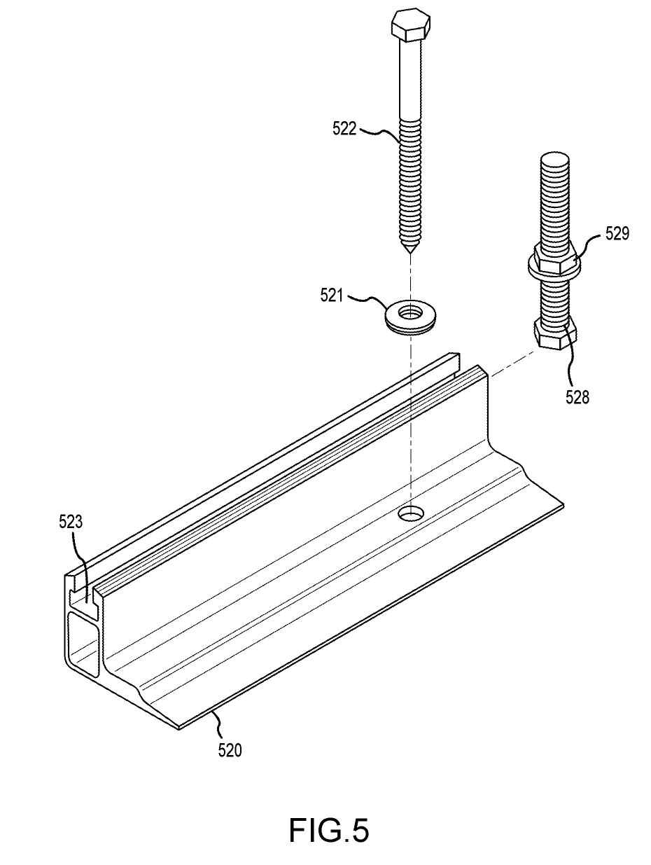

In various embodiments and with reference to FIGS. 4A-4D, upslope rail 442 may have a cross-sectional profile that is different than downslope rail 402. In this regard, downslope rail 402 may be used as the leading edge or downslope most edge of any column (e.g., column A, as shown in FIG. 4A) to support the downslope edge of solar panel 10-1 of a solar panel array 20. Subsequent upslope solar panels (e.g., solar panel 10-2) of solar panel array 20 may be supported by one or more upslope rails 442. For example, the trailing or upslope edge of solar panel 10-1 may be supported by upslope rail 442. In this regard, a portion of solar panel 10-1 (e.g., a portion of panel 10-1 associated with the trailing edge of panel 10-1) may be supported by one or more upslope rail 442. Solar panel 10-1 may also be operatively coupled and/or attached to upslope rail 442 may any suitable mechanism as described herein, including for example, one or more clamps, one or more fasteners, and/or the like. In this regard, rail 442-1 may include a shelf or similar structure as described herein, to receive and support solar panel 10-1. This arrangement may facilitate installation of solar array 20.

In various embodiments, the leading edge of solar panel 10-2 may be supported by a portion upslope rail 442-1. For example, the leading or downslope edge of solar panel 10-2 may directly engage a portion of upslope rail 442-1. Solar panel 10-2 may also be configured to engage and/or, otherwise, rock into one of more clamps that are operatively coupled to upslope rail 442-1. The upslope edge of solar panel 10-2 may be supported by, configured to engage and/or operatively coupled to upslope rail 442-2. Upslope rail 442-1 and upslope rail 442-2 may have the same general cross sectional profile. Moreover, upslope rail 442 (e.g., upslope rail 342 as shown in FIG. 3A) may have a different cross sectional profile than downslope rail 402 (e.g., downslope rail 102 as shown in FIG. 1 or downslope rail 202 as shown in FIG. 2).

In various embodiments and with reference to FIGS. 4B-4D, the layout of a solar panel array 20 may vary based on mounting space, load considerations, roof shape, roof protrusions and many other factors. In various embodiments and with reference to FIG. 4B, solar panel array 20 may have a square or rectangular layout. In this configuration, solar panel array 20 may comprise and/or be supported by a leading edge of downslope rail 402. Downslope rail 402 may include a plurality of downslope rails or segments 402-1, 402-2, 402-3, and/or the like. Each of the solar panels 10 in the first row X may be coupled to and/or supported by one or more downslope rails 402. The trailing or upslope edge of the panels 10-1, 10-2, 10-3, and/or the like may be supported by one or more upslope rails 442-1. 442-2, 442-3, and/or the like. The subsequent upslope rows Y and Z of panels may be supported on the leading and trailing edges of each panel 10 (e.g., panels 10-4, 10-5, 10-6, 10-7, 10-8, 10-9, and/or the like) by one of more upslope rails 442 (e.g., upslope rails 442-1, 442-2, 442-3, 442-4, 442-5, 442-6, 442-7, 442-8, 442-9, and/or the like).

In various embodiments and with specific reference to FIGS. 4C and 4D, array 20 may be designed to in any suitable shape. In this regard, the leading edge of each column in an array may start at the same location on the roof (e.g., columns A, B, and C shown in FIG. 4C each have a different leading edge starting positions). Moreover, columns may be interrupted (e.g., column B as shown in FIG. 4D) because of a roof structure or protrusion 30 (e.g., a plumbing vent, an antenna, a roof appliance, and/or the like).

In various embodiments, columns A and B, as show in FIG. 4C, may be installed with either downslope rail 402 and/or upslope rail 442. Where downslope rail 402 need to be coupled to an adjacent upslope rail 442 a clip 444A may be used. Clip 44B may be used to coupled adjacent sections of upslope rail 442 together. Similarly, the panel upslope of protrusion 30 in column B, as shown of FIG. 4D may be installed with either downslope rail 402 and/or upslope rail 442.

In various embodiments, the mounting systems described herein may be coupled to a roof my any suitable mount system. The mount system may include a slide 520. Slide 520 may be coupled to a roof with a fastener 522. Fastener 522 may be any suitable fastener including, for example, a screw, a law screw, a bolt, a nail, and/or the like. Fastener 522 may be sealed with seal 521. Seal 521 may be any suitable washer including, for example, an EPDM washer, a rubber washer, a metal washer, and/or the like. Slide 520 may also comprise a slot or channel 523. The mounting system may also comprise support shaft 528. Support shaft 528 may be receivable within channel 523. Moreover, support shaft 528 may be secured at any position along slot 523 of slide 520 by attachment mechanism 529 (e.g., a nut).

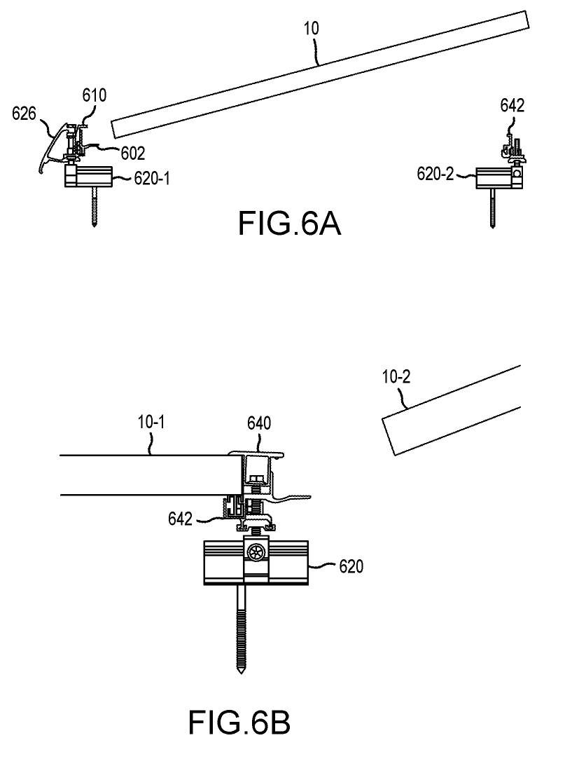

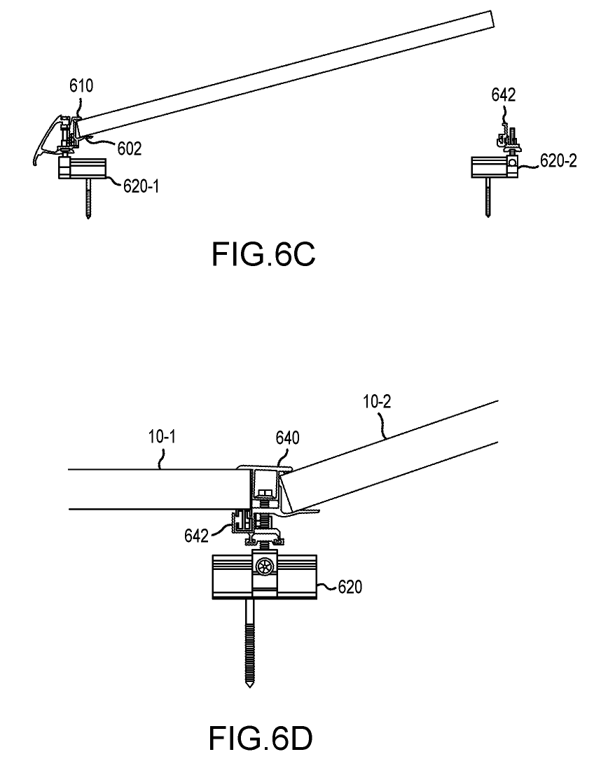

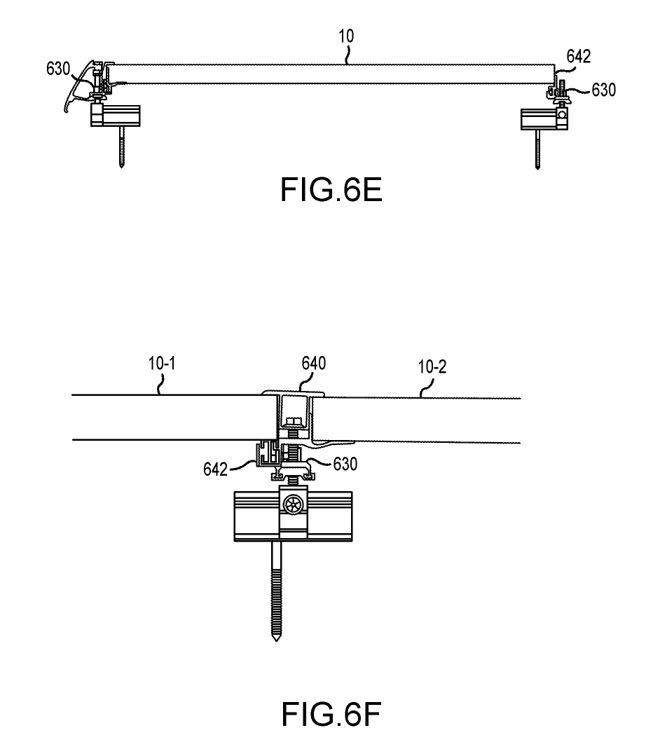

In various embodiments and with reference to FIGS. 6A-6F, downslope rail 602 may be installed on slide 620-1. First clamp 610 may be coupled to downslope rail 602. Array skirt 626 may also optionally be installed. Panel 10 may be positioned by an installer for installation on downslope rail 602. Upslope rail 642 may also be positioned at a point upslope on the roof to capture or support panel 10 as it is installed. Upslope rail 642 may also be installed on panel 10. In this regard, slide 620-2 may be positioned on the roof and may be configured to receive panel 10 and upslope rail 642. Upslope in the array, panel 10-2 may be positioned, such that the leading edge of panel 10-2 may be rocked or pivoted into mounting clip 640. After the panel is installed, first clamp 610 and/or mounting clip 640 may be adjusted to secure panel 10 as shown in FIG. 6E and panels 10-1 and 10-2 as shown in FIG. 6F.

In various embodiments, each mounting point may include leveling features. In this regard, an installer may access nut 630 from above the panels (e.g., panel 10 as shown in FIG. 6E) after installation to adjust the height of the leading edge or trailing edge of panel 10-1. Similarly, the height of two adjacent panels (e.g., panel 10-1 and panel 10-2) may be adjusted by adjusting nut 630 associated with upslope rail 642. Nut 630 of upslope rail 642 is also accessible by an installer from above the array. In this regard, the height of panels 10-1 and 10-2 relative to the roof may be adjusted.

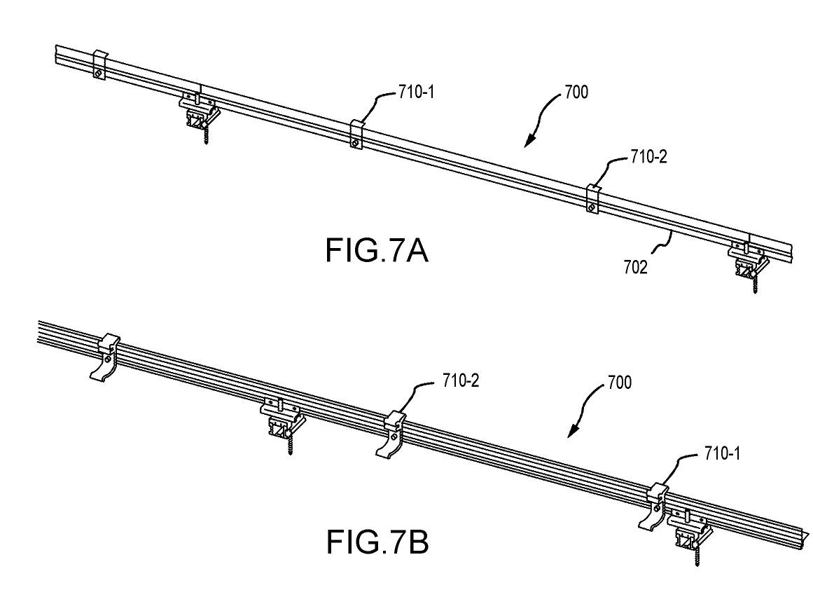

In various embodiments, the mounting system described herein may be provided with the ability to employ an array skirt. The mounting system described herein may also be provided without the ability to install an array skirt. For example, and with reference to FIG. 7A, mounting system 700 may be installed with first clamps 710-1 and 710-2 that do not include supports or shelves for an array skirt. With reference to FIG. 7B, mounting system 700 may be installed with first clamps 710-1 and 710-2 that include supports or shelves for an array skirt.

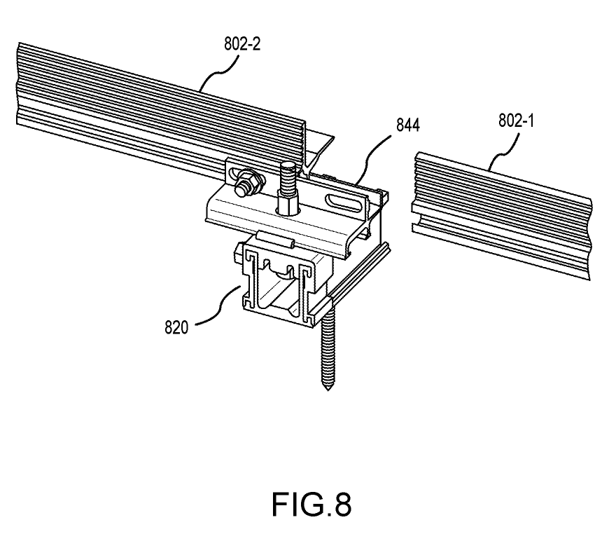

In various embodiments and with reference to FIG. 8, downslope rail 802 (shown as downslope rail 802-1 and downslope rail 802-2 in FIG. 8A) may be provided in any suitable length. For example, downslope rail 802 may be provided in panel length sections. In this regard, downslope rail 802 may be provided at a length that is slightly shorter than the length of a solar panel. Downslope rails 802 may be joined together or coupled to one another with clip 844. For example, downslope rail 802-1 may be coupled to rail 802-2 via clip 844 mounted on slide 820. Clip 844 may bridge the gap between downslope rails 802-1 and 802-2 where the rails are provided at lengths that are slightly shorter than panel length. Clip 844 may be coupled to each of downslope rails 802-1 and 802-2 with one or more fasteners. Moreover, clip 844 may be at least partially installable within a slot or channel defined in downslope rail 802-1 and/or downslope rail 802-2.

In various embodiments, downslope rail 802 may also be installed in standard lengths (e.g., 72 inch lengths, 48 lengths, and/or any other suitable length). Standard lengths may be defined by an installation region, environmental loads the panels may be subjected to, requirements of an authority having jurisdiction, requirements or preferences of an installer or integrator, as defined by the engineer designing a solar system, and/or any other standard defining entity or authority.

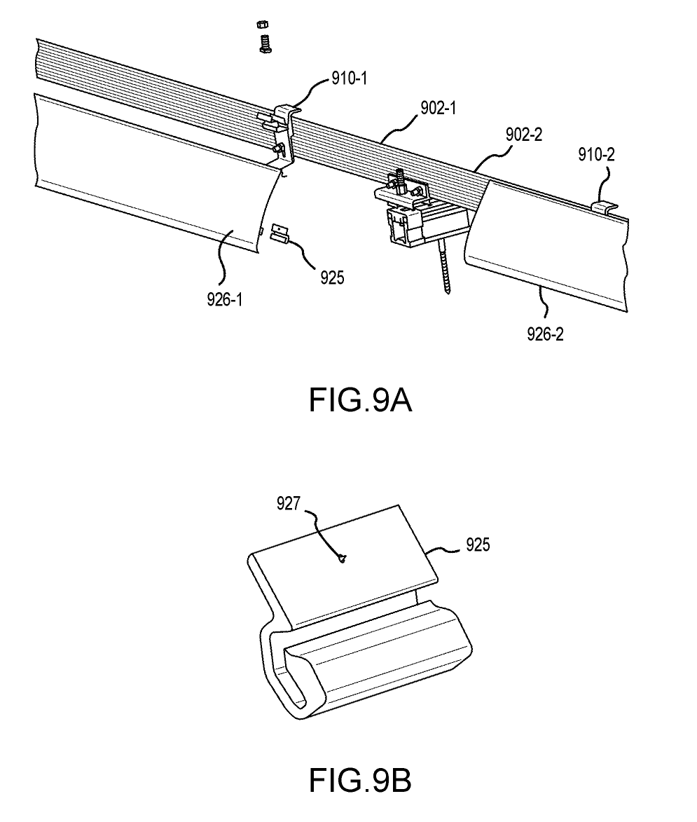

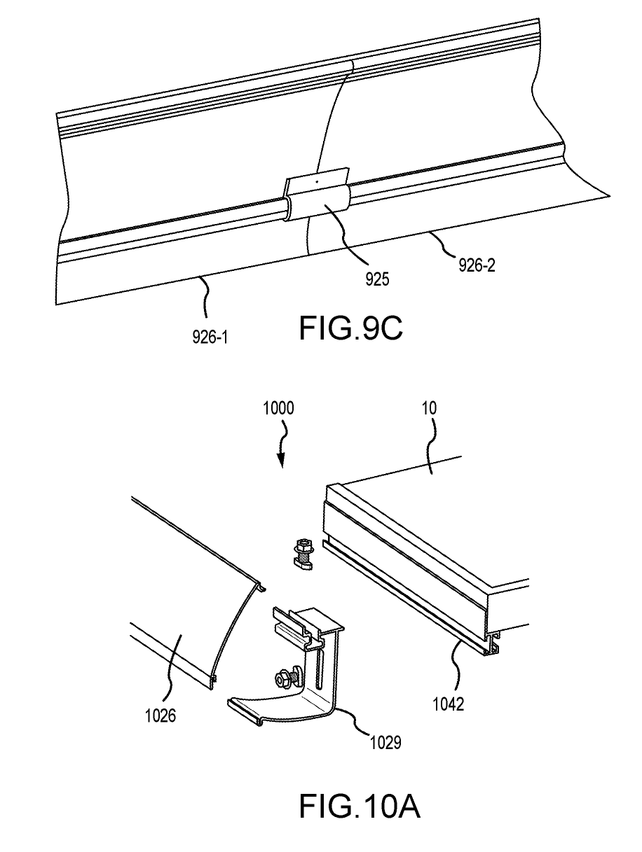

In various embodiments and with reference to FIGS. 9A-9C, array skirt 926 (shown in array skirt 926-1 and array skirt 926-2 in FIGS. 9A and 9C) may be provided at any suitable length. In this regard and like the rails discussed herein that may be provided at panel length or standard lengths, array skirt 926 may also be provided in panel lengths or in standard lengths. Array skirt 926 may also be customizable in the field. In this regard, an installer may cut array skirt 926 to a desired length. As discussed herein, array skirts 926-1 and 926-2 may be installed on one or more downslope rails 802-1, 802-2, and the like with one or more first clamps 910-1 and 910-2. Array skirts 926-1 and 926-2 may also be coupled together with a skirt clip 925. Skirt clip 925 may include an alignment dimple 927. When installed, skirt clip 925 may be operatively coupled to a channel or slot on the back surface or underside of array skirts 926-1 and 926-2. In this regard, skirt clip 925 may not be visible when installed. Moreover, array skirts 926-1 and 926-2 may be properly aligned with alignment dimple 927 when coupled together with skirt clip 925.

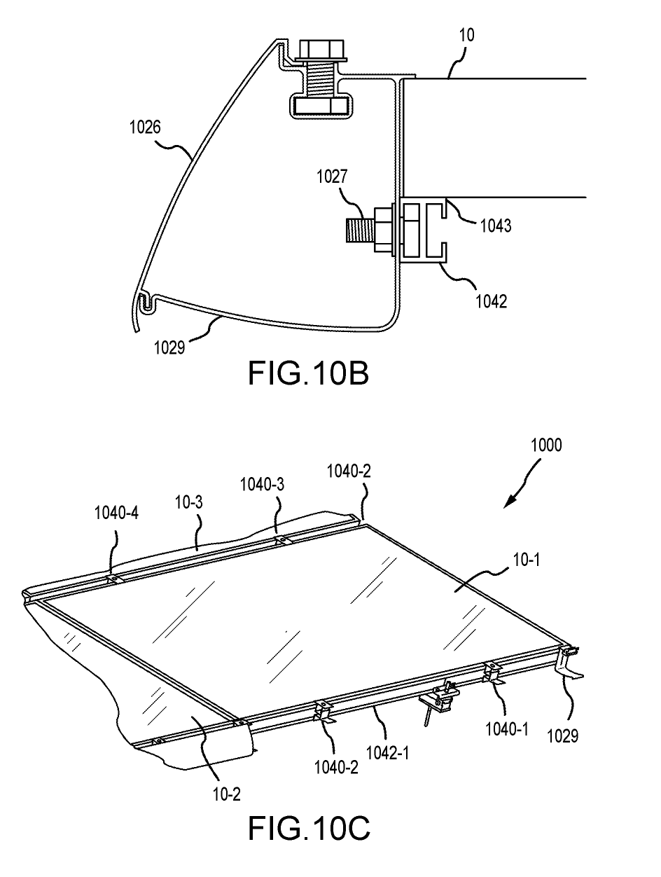

In various embodiments and with reference to FIGS. 10A-10C, mounting system 1000 may be installed using only upslope rail 1042. In this configuration, upslope rail 1042 installed along the array leading edge may be positioned so that shelf 1043 may be positioned to face upslope. In this regard, shelf 1043 may be configured to support the leading edge of panel 10-1. Subsequent upslope rails 1042-2 and the like may be installed as otherwise described herein such that rails 1042 upslope from array leading edge support the trailing edge of one or more panels 10. For example, and with specific momentary reference to FIG. 10C, the leading edge and trailing edge of panel 10-1 are support by shelves 1043 of upslope rails 1042-1 and 1042-2. The leading edge of panel 10-3 may be rocked into or pivoted into one or more mounting clips 1040-3, 1040-4 and/or the like.

In various embodiments and with reference again to FIGS. 10A-10C, mounting system 1000 may be configured to receive optional array skirt 1026. Array skirt 1026 may be coupled to upslope rail 1042. Array skirt 1026 may be coupled to a skirt bracket 1029. Skirt bracket 1029 may be configured to engage a slot or channel defined in upslope rail 1042. Skirt bracket 1029 may be retained on upslope rail 1042 by a fastener 1027. In this regard, array skirt may be installed along the array leading edge.

The systems, methods, and apparatuses described herein may be used with any suitable roof mounted structure including, for example, a solar panel array or system, and/or the like. The systems may also be used with any suitable roof system, including for example, shingle roofing systems, metal roofing systems, slate roofing systems, concrete or ceramic tile roofing systems, and/or the like.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 104(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A mounting system, comprising:
a downslope rail having a first profile and comprising a downslope face and an upslope shelf;
an upslope rail have a second profile and comprising a downslope shelf and an upslope face;
a first clamp configured to engage the downslope face and accept the installation of a first end of a solar panel; and
a second clamp configured to engage the upslope face and retain a second end of the solar panel against a downslope shelf

2. The mounting system of claim 1, wherein the downslope face comprises a plurality of serrations.

3. The mounting system of claim 2, wherein the first clamp is configured to engage the plurality of serrations.

4. The mounting system of claim 1, wherein the solar panel is configured to pivot into the first clamp.

5. The mounting system of claim 4, wherein the solar panel is configured to create an upward load on the first clamp in response to the pivoting.

6. The mounting system of claim 4, wherein the solar panel causes the first clamp to load the serrations in response to the pivoting.

7. The mounting system of claim 1, wherein the upslope shelf includes a fulcrum.

8. The mounting system of claim 7, wherein the solar panels rocks into a channel defined between the first clamp and the up slope shelf

9. The mounting system of claim 8, wherein the solar panels rocks on the fulcrum.

10. The mounting system of claim 1, wherein the downslope rail includes a slot that is configured to receive a fastener.

11. The mounting system of claim 10, wherein the first clamp is configured to receive a portion of the fastener.

12. The mounting system of claim 1, wherein the first clamp is configured to support an array skirt.

13. The mounting system of claim 1, wherein the first clamp comprises a support slot and a support shelf

14. The mounting system of claim 13, wherein an array skirt is configured to engage the support slot and the support shelf
